(19) United States
(12) Patent Application Publication
(10) Pub. No.: US 2009/0121648 A1
(43) Pub. Date: May 14, 2009

(54) Lighting Device

(76) Inventors: Han Cheng Geng, Zhejiang (CN); Qi Guang Huang, Zhejiang (CN)

Correspondence Address: JAMES C. WRAY, 1493 CHAIN BRIDGE ROAD, SUITE 300, MCLEAN, VA, 22101, US

(21) Appl. No.: 12/083,880

(22) PCT Filed: Oct. 23, 2006
(86) PCT No.: PCT/IB2006/003665

§ 371 Date: Jul. 23, 2008

(30) Foreign Application Priority Data
Oct. 21, 2005 (CN) 200520116114.9
Aug. 15, 2006 (GB) 0616186.3

(51) Int. Cl. H05B 41/14

(52) U.S. Cl. 315/291

(57) ABSTRACT

A lighting device (101), comprising: an electrical connector (104) for fitting in a lamp socket; a fluorescent tube; an electrode (105) for ionising air, and a ballast circuit (301) configured to supply suitable electrical currents and voltages to the fluorescent tube (102) during starting and subsequent operation. The lighting device also has an ion generator circuit (302) configured to receive a relatively low ac voltage from the connector and supply a relatively high dc voltage to the electrode. The ion generator circuit itself comprises: a transformer (L41) having a primary winding and a secondary winding; and a semiconductor device (S41) connected in series with the primary winding. The semiconductor device is configured such that for voltages up to a threshold voltage the semiconductor device provides a very high resistance and for voltages above the threshold voltage the semiconductor device provides a low resistance. Consequently, in use, a current is generated in the primary winding when voltage across the semiconductor device rises to the threshold voltage.

### CROSS REFERENCE TO RELATED APPLICATION

This application claims priority from Chinese Patent Application No. 200520116114.9, filed 21 Oct. 2005, and from British Patent Application No. 06 16 186.3, the entire disclosures of which are incorporated herein by reference in its entirety.

### TECHNICAL FIELD

The present invention relates to lighting device comprising an electrical connector for fitting in a lamp socket and a fluorescent tube.

### BACKGROUND OF THE INVENTION

Energy saving lamps are known which comprise a high voltage negative ion generator. Thus these device provide illumination and air depuration. A problem with such lamps is their slow speed of generating negative ions when the lamp is started.

### BRIEF SUMMARY OF THE INVENTION

According to the present invention, there is provided a lighting device, comprising: an electrical connector for fitting in a lamp socket; a fluorescent tube; an electrode for ionising air; a ballast circuit configured to supply suitable electrical currents and voltages to the fluorescent tube during starting and subsequent operation; and an ion generator circuit configured to receive a relatively low ac voltage from said connector and supply a relatively high dc voltage to said electrode, wherein said ion generator circuit comprises: a transformer having a primary winding and a secondary winding; and a semiconductor device connected in series with said primary winding, said semiconductor device being configured such that for voltages up to a threshold voltage said semiconductor device provides a very high resistance and for voltages above said threshold voltage said semiconductor device provides a low resistance, so that in use a current is generated in said primary winding when voltage across said semiconductor device rises to said threshold voltage.

### BRIEF DESCRIPTION OF THE SEVERAL VIEWS OF THE DRAWINGS

FIG. 1 shows a lighting device 101 embodying the present invention;

FIG. 2 shows a partial cutaway view of the lighting device 101;

FIG. 3 shows a circuit diagram of the electronic ballast circuit 301 with the position of the ion generator circuit 302; and

FIG. 4 shows a circuit diagram of the ion generator circuit 302.

### DESCRIPTION OF THE BEST MODE FOR CARRYING OUT THE INVENTION

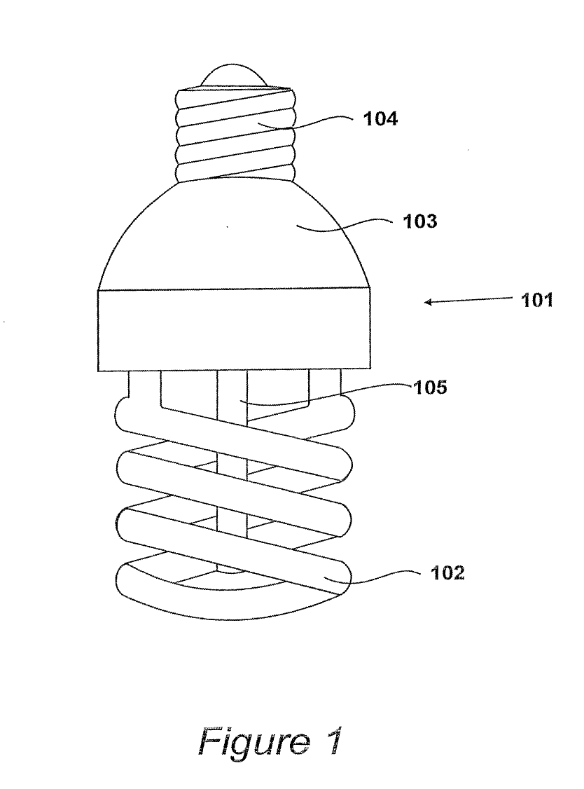

### FIG. 1

A lighting device 101 embodying the present invention is shown in FIG. 1. The device 101 has many components in common with known compact fluorescent lamps, including a helically shaped fluorescent tube 102, a housing 103 and an electrical connector 104 for connection to a mains electricity lamp socket.

The fluorescent tube 102 is similar to those known in the art, and therefore contains low pressure mercury vapour and has an inside surface coated with a phosphor layer. At each of its ends, the tube 102 contains a filament which is used to generate electrons and apply an electrical potential across the length of the tube.

The electrical connector 104 is a screw-type connector commonly found on incandescent lamps, but in alternative embodiments the connector 104 is a bayonet connector, also of a type found on incandescent lamps. However, in each case the device 101 has a connector configured such that it may be used to replace an incandescent lamp.

The device also has an ion generator electrode 105 in the form of a brush, comprising a plurality of fine conductive filaments, of a type found in existing ionisers. The filaments are provided with sharp points to facilitate generation of ions during use.

During operation, mains electricity (240V or 120V and 50 H or 60 Hz) is supplied to the connector 104, and consequently the fluorescent tube 102 emits light while the end 106 of the electrode 105 ionises and ejects neighbouring air molecules.

In the present embodiment the device 101 is provided with a single ion generator electrode 105, but other devices are envisaged which have several such electrodes.

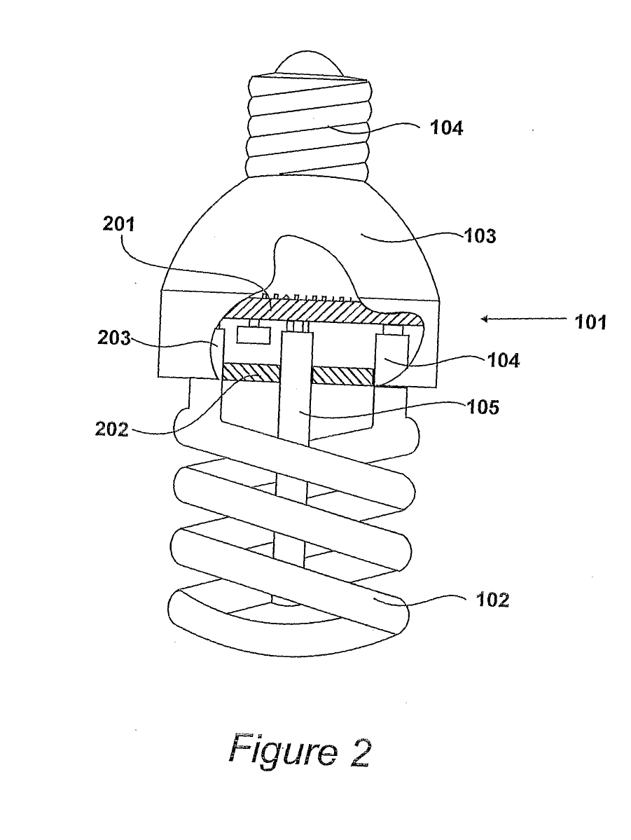

### FIG. 2

A partial cutaway view of the lighting device 101 is shown in FIG. 2.

The housing 103 contains a circuit board 201 arranged substantially parallel with an outer wall 202 of the housing. The two end portions 203 and 204 of the fluorescent tube 102 extend through the outer wall 202 to the circuit board where a pair of electrical connectors at each end of the tube connect to the circuit board. The ion generator electrode 105 is also electrically connected to the circuit board and extends though the outer wall 202 and along the axis of the helix formed by the tube 102.

The circuit board 201 contains an electronic ballast circuit for providing suitable electrical currents and voltages to the tube 102 during starting and subsequent operation. In addition, the circuit board 201 contains an ion generator circuit for providing high negative voltages, of between −4000 and −6000 volts, to the electrode 105.

In the present embodiment, the ballast circuit and the ion generator circuit are built on one circuit board, but in other embodiments each of the circuits is provided on a separate board. However, in each embodiment the ballast circuit and the ion generator circuit are located within the housing of the lighting device.

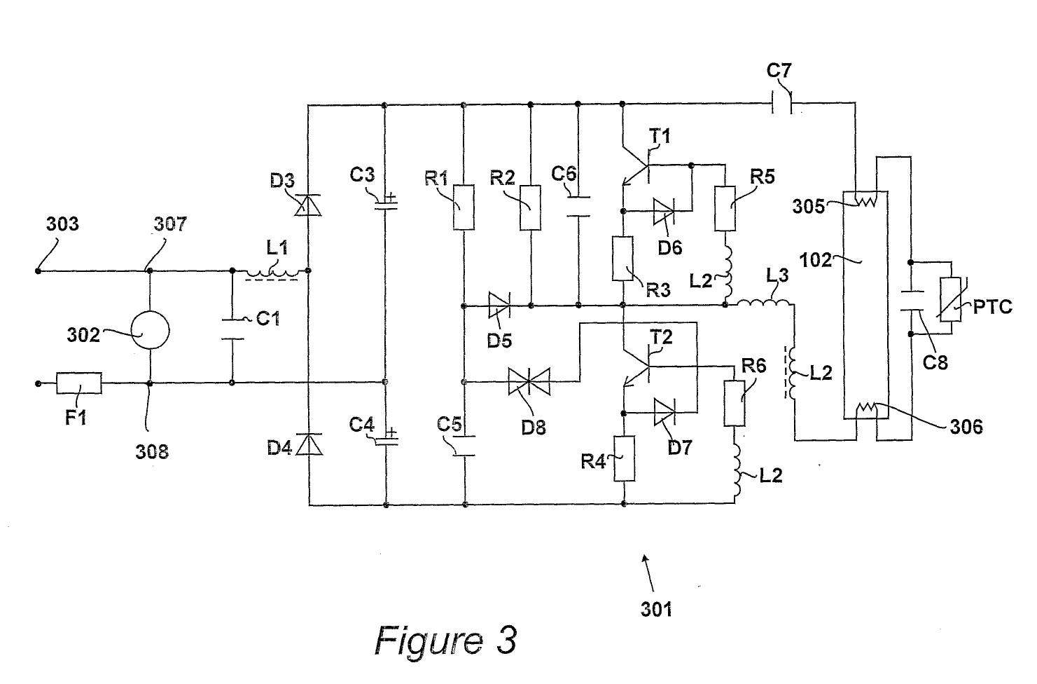

### FIG. 3

A circuit diagram of the electronic ballast circuit 301 with the position of the ion generator circuit 302 is shown in FIG. 3.

The ballast circuit 300 comprises: capacitors C1, C3, C4, C5, C6, C7 and C8; inductors L1 and L3; a transformer L2; transistors T1 and T2; diodes D1, D2, D3, D4, D5, D6 and D7; Zenner diode D8; resistors R1, R2, R3, R4, R5, R6; a PTC (positive temperature coefficient) thermistor; and a fuse F1.

The ballast circuit receives mains ac electricity at terminals 303 and 304. As is known in the art, the ballast circuit has components which prevent it from producing interference on the mains supply, rectify the ac voltage and filter the rectified voltage. Also, an oscillator part of the ballast circuit generates high frequency current, of typically thirty to fifty kilohertz (30 kHz to 50 kHz), in the secondary winding of transformer L2 for supply to the compact fluorescent tube 102.

The circuit also has a PTC (positive temperature coefficient) thermistor in parallel with capacitor C8 and the tube 102. The PTC thermistor has a relatively low resistance at room temperature but is designed such that once a switching temperature is reached the resistance rises sharply. Consequently, in operation the PTC thermistor allows current to pass through filaments 305 and 306 of the tube 102 when power is initially applied, while voltage across the tube is kept relatively low. When the PTC thermistor goes high resistance, the oscillator part produces a high voltage across the capacitor C8 and the tube, so that the tube is started.

As may be seen in FIG. 3, the ion generator circuit 302 also receives mains electricity via terminals 307 and 308.

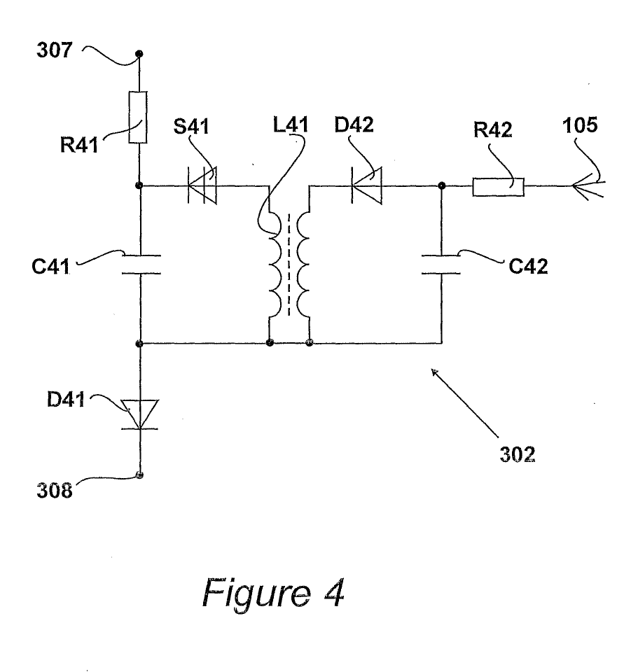

### FIG. 4

A circuit diagram of the ion generator circuit 302 is shown in FIG. 4.

Mains electricity is supplied to the terminals 307 and 308 of the ion generator circuit 302. An input resistor R41 is connected at one side to the terminal 307 and at the other to one side of a capacitor C41. The other side of the capacitor C41 is connected to one lead of an input diode D41 which has its second lead connected to the second input terminal 308. The diode D41 is arranged to allow a negative flow from the input terminal 308 to the capacitor C41.

A unidirectional GIV series semiconductor (sidac) S41 connects the resistor side of the capacitor C41 to one end of a primary winding of a transformer L41; the other end of the primary winding being connected to the diode side of said capacitor. The transformer has more turns on the secondary windings than the primary so that voltages induced across the secondary winding are sufficiently high.

A second diode D42 is connected in series with a second capacitor C42 across the secondary winding of the transformer L41. The junction of the diode D42 and capacitor C42 is connected to the electrode 105 via a resistor R42 which provides a high impedance to the output, thereby limiting the output current to safe levels if touched during operation.

During operation, the first capacitor C41 charges up until a threshold voltage of the sidac S41 is reached. A current then surges through the sidac to discharge the capacitor C41, thereby producing a large current pulse through the transformer primary winding. Consequently, a high voltage pulse is induced in the secondary winding which charges up the capacitor C42 via diode D42. Thus, the electrode 105 is held at high negative voltages, of typically between −4000 and −6000 volts.

Although the present embodiment uses capacitor C41 to store a charge for discharge through the transformer primary winding, other arrangements which perform the function of building up a sufficient charge and providing a triggering voltage to the semiconductor device S41 are envisaged.

The electronic ballast circuit 301 has been provided as an example of a ballast circuit and it will be understood that other known circuits may be used in place of circuit 301. However, in each embodiment of the invention the lighting device comprises a ion generator circuit having a semiconductor device of a type which exhibits a very high resistance for applied voltages up to a threshold voltage and exhibits a low resistance for voltages above said threshold voltage.

1. A lighting device, comprising:
an electrical connector for fitting in a lamp socket;
a fluorescent tube;
an electrode for ionising air;
a ballast circuit configured to supply suitable electrical currents and voltages to the fluorescent tube during starting and subsequent operation; and
an ion generator circuit configured to receive a relatively low ac voltage from said connector and supply a relatively high dc voltage to said electrode,
wherein said ion generator circuit comprises:
a transformer having a primary winding and a secondary winding; and
a semiconductor device connected in series with said primary winding, said semiconductor device being configured such that for voltages up to a threshold voltage said semiconductor device provides a very high resistance and for voltages above said threshold voltage said semiconductor device provides a low resistance, so that in use a current is generated in said primary winding when voltage across said semiconductor device rises to said threshold voltage.

2. A lighting device according to claim 1, wherein said ion generator circuit further comprises a capacitor arranged to be charged by said relatively low voltage, and said device is arranged to discharge said capacitor through said primary winding.

3. A lighting device according to claim 1, wherein said semiconductor device comprises a sidac.

4. A lighting device according to claim 1, wherein said fluorescent tube is a compact fluorescent tube and said device has just a single electrical connector.

5. A lighting device according to claim 1, wherein said ballast circuit is an electronic ballast circuit having an oscillator portion for generating a higher frequency than that of the relatively low ac voltage.

6. A lighting device according to claim 1, wherein said device comprises more than one electrode for ionising air.

7. A lighting device according to claim 6, wherein said fluorescent tube has a helical form defining an axis, and said electrode extends along said axis.
